(19) United States
(12) Patent Application Publication
(10) Pub. No.: US 2026/0003820 A1
(43) Pub. Date: Jan. 1, 2026

(54) VERSATILE ACCELERATOR DESIGN FOR MULTIPLE DEEP NEURAL NETWORK APPLICATIONS

(71) Applicant: The George Washington University, Washington, DC (US)

(72) Inventors: Jiaqi YANG, Arlington, VA (US); Hao ZHENG, Orlando, FL (US); Ahmed LOURI, Vienna, VA (US)

(21) Appl. No.: 19/254,706

(22) Filed: Jun. 30, 2025

Related U.S. Application Data
(60) Provisional application No. 63/665,776, filed on Jun. 28, 2024.
(60) Provisional application No. 63/752,715, filed on Feb. 1, 2025.

(51) Int. Cl. G06F 15/78; G06F 9/48; G06F 15/80; G06N 3/10

(52) U.S. Cl. CPC G06F 15/7871; G06F 9/4881; G06F 15/8015; G06N 3/10

(57) ABSTRACT

Emerging applications utilize numerous Deep Neural Networks (DNNs) to address multiple tasks simultaneously. As these applications continue to expand, there is a growing need for off-chip memory access optimization and innovative architectures that can adapt to diverse computation, memory, and communication requirements of various DNN models. To address these challenges, Versa-DNN is a versatile DNN accelerator that can provide efficient computation, memory, and communication support for the simultaneous execution of multiple DNNs. Versa-DNN features three unique designs: a flexible off-chip memory access optimization strategy, adaptable communication fabrics, and a communication and computational aware scheduling algorithm. The off-chip memory optimization strategy improves performance and energy efficiency by increasing hardware utilization, eliminating excess data duplication, and reducing off-chip memory accesses. The adaptable communication fabrics include distributed buffers, processing elements, and a flexible Network-on-Chip (NoC), which can dynamically morph and fission to support distinct communication and computation needs for simultaneously running DNN models. Furthermore, Versa-DNN has a scheduling policy which manages the simultaneous execution of multiple DNN models with improved performance and energy efficiency.

### RELATED APPLICATIONS

This application claims the benefit of priority of U.S. Application No. 63/665,776, filed Jun. 28, 2024, and 63/752,715, filed Feb. 1, 2025, the content of which is relied upon and incorporated herein by reference in their entirety.

### BACKGROUND

### Background of the Related Art

### DNNs Workload

Deep Neural Networks (DNNs) have been widely used in many applications, such as image recognition, speech recognition, and natural language processing. These networks are composed of a number of convolutional layers, each of which can be formulated as a nested loop with multiple attributes (e.g., N, K, C, R, S, Y, X), as shown in FIGS. 1(a), 1(b) (stride=1), to represent the batches of the input activation (N), the number of input channels (C), the number of output channels (K), and the width and height of weight filter (S, R), input activation (X, Y), and output activation (X′=X−S+1, Y′=Y−R+1). The operation of each convolutional layer is primarily composed of high-dimensional convolutions as shown in FIGS. 1(a), 1(b). Each convolutional layer of a Deep Neural Network (DNN) computes an output activation tensor by convolving the input activations with a set of learnable weights. Specifically, for each output channel, the input activations are first convolved with a corresponding weight kernel within the same input channel, and the results are then accumulated across all input channels to generate the final output value at each spatial location. By applying different weight kernels to the same input, multiple output channels (also referred to as output feature maps) can be produced. This structure allows for high degrees of spatial and batch-level parallelism, making it suitable for optimized execution on hardware accelerators.

### DNNs Dataflows

DNN dataflow refers to the parallelism strategies that can efficiently exploit both spatial and temporal data reuse. In general, there are several types of commonly used dataflows, including weight-stationary, input-stationary, output-stationary, and row-stationary dataflows.

Weight-Stationary Dataflow (WS): In weight-stationary dataflow, the weights are preloaded to PE array, and the input data is streamed through the network. In this dataflow, the loop order for computations is arranged to ensure that the weight values, K, C, R or S, are placed in the outermost loop. As a result, the input activations are in the inner loops. This allows the same weight values to be reused multiple times for different input activations, improving memory access efficiency. The WS dataflow can benefit large convolutional neural networks where the weight matrices can be very large and expensive to store and access.

Input-Stationary Dataflow (IS): In input-stationary dataflow, the input data are stored in local register, and the weight is streamed through the network. In this dataflow, the loop order for computations is arranged in a way that the input data, N, C, X or Y, are accessed in the outermost loop, followed by the weight in the inner loops. This allows the same input activations to be reused multiple times for different weight, improving memory access efficiency. As such, it can significantly reduce the data movement when the input matrix is large.

Output-Stationary Dataflow (OS): Like WS and IS dataflows, output-stationary dataflow is designed to retain output matrix in the local register for partial sum accumulation. Consequently, the weights and inputs flow through PE array to produce partial results. The data movement can be significantly reduced when partial row accumulation happens frequently.

Row-Stationary Dataflow (RS): RS dataflow is an alternative means to explore the data reuse, in which input, weight, and output data are temporarily reused at row-wise (i.e., staying within a same row). N, K, X′, or Y′ dimensions are arranged in the outermost loop, and it is beneficial for applications with large input and output data. RS Dataflow keeps data in the same row to avoid remote communication. Weight stationary (FIG. 7(a)), input stationary (FIG. 7(a)), and output stationary (FIG. 7(c)) are also provided and, in other embodiments, column stationary and/or diagonal stationary can optionally be provided.

Overall, the choice of dataflow mainly depends on the specific requirements of the application and the available hardware resources. Given the high dimensionality of DNNs, dataflow is a critical factor for off-chip memory access and computation performance.

### SUMMARY

A Versa-DNN, a versatile and reconfigurable Deep Neural Network (DNN) accelerator is designed to efficiently support the concurrent execution of multiple DNN models. Versa-DNN addresses the challenges of modern AI workloads by optimizing off-chip memory access, reducing redundant communication, and adapting to diverse computation and dataflow requirements.

Versa-DNN employs a tile-based architecture, where each tile includes a distributed buffer, a local array of processing elements (PEs), and a reuse FIFO to enable intra- and inter-tile data movement. The system integrates a flexible Network-on-Chip (NoC) composed of switchable directional and diagonal links, allowing the dynamic formation of localized communication topologies such as ring networks. This structure enables hop-to-hop, low-latency data propagation and enhances energy efficiency.

A core feature of Versa-DNN is its adaptive dataflow and memory access optimization mechanism. By analyzing DNN model attributes and selecting optimal parallelism factors, the system significantly reduces off-chip memory traffic and maximizes on-chip data reuse. This design is particularly beneficial for multi-DNN scenarios where resource contention and data duplication are prevalent.

To further enhance scalability, Versa-DNN incorporates a communication- and computation-aware scheduling algorithm. This runtime controller dynamically partitions hardware resources and reconfigures interconnect topologies based on the characteristics of each DNN model, achieving improved performance and load balancing across workloads.

Versa-DNN is well-suited for heterogeneous AI applications such as autonomous systems, cloud-based inference engines, and edge computing platforms. Empirical evaluations across diverse DNN benchmarks show that Versa-DNN achieves substantial improvements in throughput and energy efficiency compared to existing multi-DNN accelerators.

In one embodiment, the system includes: (i) a tiled processing architecture with distributed buffers and spatially organized PEs; (ii) a reconfigurable NoC with selectable inter-tile communication paths; (iii) a configurable dataflow engine that reduces memory access overhead; and (iv) a dynamic runtime scheduler that orchestrates concurrent execution of multiple DNNs.

This system provides a scalable, adaptable, and efficient hardware foundation for accelerating multi-DNN workloads across a wide range of deployment environments.

Emerging applications utilize numerous Deep Neural Networks (DNNs) to address multiple tasks simultaneously. As these applications continue to expand, there is a growing need for off-chip memory access optimization and innovative architectures that can adapt to diverse computation, memory, and communication requirements of various DNN models. To address these challenges, Versa-DNN is a versatile DNN accelerator that can provide efficient computation, memory, and communication support for the simultaneous execution of multiple DNNs. Versa-DNN features three unique designs: a flexible off-chip memory access optimization strategy, adaptable communication fabrics, and a communication and computational aware scheduling algorithm. The off-chip memory optimization strategy improves performance and energy efficiency by increasing hardware utilization, eliminating excess data duplication, and reducing off-chip memory accesses. The adaptable communication fabrics include distributed buffers, processing elements, and a flexible Network-on-Chip (NoC), which can dynamically morph and fission to support distinct communication and computation needs for simultaneously running DNN models. Furthermore, Versa-DNN has a scheduling policy which manages the simultaneous execution of multiple DNN models with improved performance and energy efficiency. Simulation results using several DNN models, show that the Versa-DNN architecture achieves 41%, 238%, 392% throughput speedup and 30%, 59%, 63% energy reduction on average for different workloads when compared to state-of-the-art accelerators such as Planaria, Herald, and AI-MT, respectively.

In more detail, Deep Neural Networks (DNNs) have emerged as the backbone of numerous artificial intelligence applications to infer complex decisions. Specialized hardware accelerators, such as GPUs and TPUs, have been developed to expedite the training and inference of DNNs. However, there has been a surge in applications that require the concurrent execution of multiple complex functionalities, such as vision-centric autonomous systems and Cloud-based systems [1], [2]. For example, today's computer vision tasks, such as object detection and semantic segmentation, involve multiple DNN models to achieve accurate perception. Similarly, a set of DNNs are combined to enhance the quality of camera-captured content or provide advanced augmented reality features [3].

Despite the surge of multi-DNN models, it remains a challenge to facilitate the multi-DNN execution due to distinct computation and communication characteristics. For example, DNN models often involve varying operations and layer sizes, all with unique computation and communication ratios and memory access patterns. Current DNN accelerators are mostly optimized for a given set of DNN models, and thus they are inefficient in handling various computation and communication characteristics. For example, the datapath of Eyeriss [4] is optimized to handle row-stationary dataflow, and it has limited applicability to support other dataflows. The problem is further exacerbated by resource contention, as network-on-chip, computation units, and memory are shared among running DNN models.

Significant research efforts [1], [3], [5], [6], [7] have been dedicated to enhancing the performance and energy efficiency of simultaneously accelerating multiple DNNs on the same accelerator. However, current multi-DNN accelerators have not yet addressed all the challenges. For instance, Herald [1] provides multiple accelerator options with different memory access optimization techniques, but the computing and memory capabilities are determined at the design stage, making it challenging to adapt to the dynamic demands and interactions of running DNNs. Similarly, AI-MT [5] adopts a systolic array architecture that is not efficient at handling a variety of off-chip memory access optimization strategies, as its data path only supports a specific type of data movement.

Planaria [6] proposes a flexible accelerator architecture that can be dynamically partitioned to accommodate several DNN models, in which compute and memory resources are dynamically determined and allocated. While the dynamic resource allocation can alleviate the resource underutilization issue, its rigid dataflow design still prevents the further optimization such as reduced off-chip memory access. Moreover, like Herald [1], MAGMA [8] and Veltair [9], Planaria [6]'s scheduling policy only considers compute resources and neglects the impacts of communication latency. On the other hand, AI-MT [5], PREMA [7], and LayerWeaver [10] adopt a time-multiplexing approach to interleave the execution of multiple DNN models based on their computational impacts. Such scheduling policies are unlikely to be generalized to handle the spatial resource management.

There is a pressing need for further research to improve the performance and energy efficiency of multi-DNN accelerators. To this end, a Versa-DNN, a versatile DNN accelerator provides efficient computation, memory, and communication support for the simultaneous execution of multiple DNNs. The main contributions of this system include:

An adaptable accelerator fabric has distributed buffers, processing elements, and a flexible Network-on-Chip (NoC), which can dynamically morph and fission to simultaneously support distinct communication needs for running DNN models.

Various parallelism strategies (i.e., how to use the multiple processors to execute multiDNN workload at same time, and specifically how to map the multiDNN workload to multiple processors) for multiDNN accelerators compatible with distributed buffer configurations. The off-chip memory access optimization strategy selection algorithm can select suitable parameters for parallel DNN execution to avoid data duplication, thus trading off expensive and energy-inefficient off-chip memory access for energy-efficient on-chip data movement. More importantly, the strategy maintains the simplicity of on-chip data movement with hop-to-hop communications, whereby every tile only communicates with the neighboring tiles.

A communication and computational aware scheduling algorithm for accelerator partition and hardware configuration. The algorithms can dynamically select suitable accelerator partitioning strategies and interconnection configurations with the aim of satisfying both computation and communication resource constraints.

We evaluate the Versa-DNN with a cycle-accurate simulator that can accurately capture the behavior of each hardware component of the DNN accelerator. Our evaluation uses the same benchmark DNN models as compared to state-of-the-art accelerators, and the simulation results demonstrate that our Versa-DNN architecture achieves 41%, 238%, 392% throughput speedup and 30%, 59%, 63% energy reduction on average for different workloads when compared to Planaria [6], Herald [1], and AI-MT [5], respectively. We believe that the Versa-DNN accelerator provides a significant addition to the design of high-performance and energy-efficient multi-DNN accelerators.

These and other objects of the disclosure, as well as many of the intended advantages thereof, will become more readily apparent when reference is made to the following description, taken in conjunction with the accompanying drawings. This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

FIG. 1(a) shows a convolutional DNN layer example;

FIG. 1(b) shows a tiled convolutional DNN layer example;

FIG. 2 shows the Versa-DNN Accelerator Architecture (an example of a 4×4 architecture);

FIG. 3(a) is a tile architecture;

FIG. 3(b) is a PE architecture;

FIG. 4(a) is a router architecture;

FIG. 4(b) shows a horizontal switch;

FIG. 4(c) shows a vertical switch;

FIG. 5(a) is a nested loop representation of the parallelism strategy and mapping example of the conventional WS dataflow;

FIG. 5(b) is a nested loop representation of the parallelism strategy and mapping example of the dataflow;

FIG. 6 shows all the supported dataflows in the Versa-DNN accelerator;

FIGS. 7(a)-(c): Topology configurations of FIG. 7(a) weight stationary/input stationary dataflow, FIG. 7(b) row stationary dataflow, and FIG. 7(c) output stationary dataflow with different parallelism strategies;

FIG. 8 is a time stamp of normalized efficient on-chip distributed buffer capacity utilization of conventional weight stationary dataflow (WS) [14], row stationary dataflow (RS) [4], output stationary dataflow (OS) [35], the average of compared conventional dataflows, and dataflow in a single layer of DNN model VGG-16 [34]. T is the execution time of a single layer of DNN model VGG-16;

FIG. 9: Normalized efficient on-chip distributed buffer capacity utilization of conventional weight stationary dataflow (WS) [14], row stationary dataflow (RS) [4], output stationary dataflow (OS) [35], the average of compared conventional dataflows, and dataflow in each convolutional layer of DNN model VGG-16 [34], normalized to efficient on-chip distributed buffer capacity utilization of dataflow;

FIG. 10: Normalized DRAM Access of conventional weight stationary dataflow (WS) [14], row stationary dataflow (RS) [4], output stationary dataflow (OS) [35], the average of compared conventional dataflows, and dataflow in each convolutional layer of DNN model VGG-16 [34], normalized to DRAM Access of dataflow;

FIGS. 11(a)-11(c): Normalized DRAM Access for each workload scenario by using our accelerator and compared accelerators (FIG. 11(a) Planaria [6], FIG. 11(b) Herald [1], and FIG. 11(c) AI-MT [5]), normalized to DRAM Access of compared accelerators respectively;

FIGS. 12(a)-(c): Normalized throughput for each workload scenario by using our accelerator and compared accelerators (FIG. 12(a) Planaria [6], FIG. 12(b) Herald [1], and FIG. 12(c) AI-MT [5]), normalized to throughput of compared accelerators respectively.

FIGS. 13(a)-(c): Normalized energy consumption for each workload scenario by using our accelerator and compared accelerators (FIG. 13(a) Planaria [6], FIG. 13(b) Herald [1], and FIG. 13(c) AI-MT [5]), normalized to the energy consumption of compared accelerators respectively.

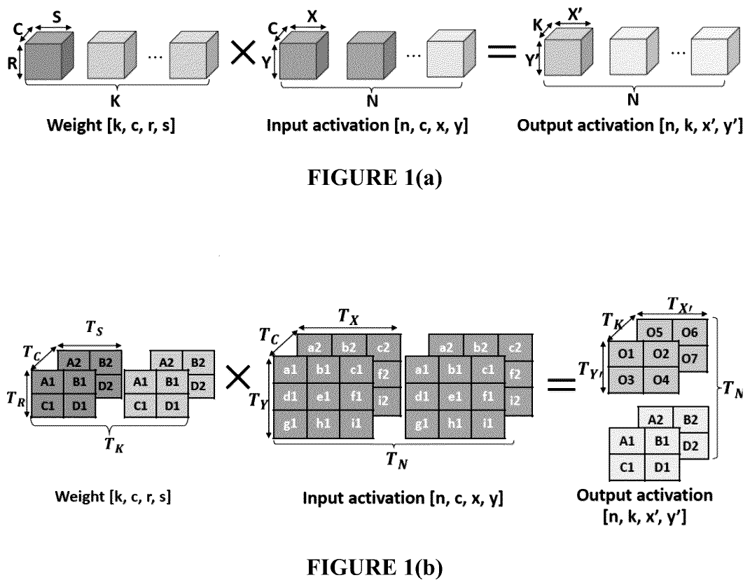

### DETAILED DESCRIPTION

In describing the illustrative, non-limiting embodiments of the disclosure illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments of the disclosure are described for illustrative purposes, it being understood that the disclosure may be embodied in other forms not specifically shown in the drawings.

The versatile Deep Neural Network (DNN) accelerator, referred to here as Versa-DNN, is designed to support multiple applications with efficient communication and computation capabilities. Versa employs a tile-based architecture with distributed buffering, where each tile comprises an array of processing elements (PEs) and a portion of the distributed buffer. Additionally, Versa features a flexible Network-on-Chip (NoC) that can dynamically adapt to the communication requirements of various running applications. This adaptability maximizes data reuse, reduces Dynamic Random Access Memory (DRAM) accesses, and supports multiple dataflows, ultimately aiming for improved execution time and energy efficiency.

The Versa-DNN accelerator has multiple applications including but not limited to: (1) A comprehensive exploration of dataflows and identification of suitable ones that can trade off expensive off-chip memory accesses with cheap on-chip data movement. (2) A versatile accelerator architecture to support multiple application execution. The accelerator adopts a tiled architecture design, where each tile has a distributed buffer and an array of PEs. The flexible NoC can dynamically be configured to support various traffic patterns of a given dataflow for any given running application. (3) A new algorithm for hardware configuration. The algorithm can dynamically construct the interconnection configurations, aiming to provide higher performance and energy efficiency.

The integration of distributed buffers with flexible dataflows addresses the limitations of existing DNN accelerators that rely on centralized buffer architectures. The Versa-DNN aims to eliminate excessive data duplication, reduce off-chip memory access overheads, and enhance on-chip data reuse. The architecture is a significant advancement in multi-application and multi-tenant DNN accelerators, offering improved bandwidth, data reuse, and concurrent execution capabilities.

The Versa-DNN accelerator design addresses the challenges of memory bandwidth and communication requirements in DNN applications. The architecture offers significant performance and energy efficiency improvements over existing designs, making it a valuable contribution to the field of deep learning hardware acceleration.

### Versa-DNN Design

DNN models are composed of different operations and layers, each with their own computation and communication ratio and memory access patterns. This necessitates the use of contemporary DNN accelerators that are capable of managing various computation and communication characteristics at the same time. In addition, resource contention is another major concern that limits the accelerator performance. The goal of the present design is to simultaneously address the computation and communication challenges when running multiple DNNs with distinct characteristics. To achieve this, a novel framework is provided to support the simultaneous execution of DNNs spanning architecture, dataflow, and scheduling. Specifically, we provide three unique designs: (1) universal and modular memory and communication fabrics to support dynamic architecture partitioning, (2) a flexible dataflow to pursue both communication simplicity and dataflow flexibility, and (3) a scheduling algorithm to consider the effects of communication and computation. The details of the architecture and dataflow will be discussed below.

### Overall Versa-DNN Architecture Design

As shown in FIG. 2, the overall Versa-DNN system architecture 100 includes an on-chip control unit 102 and multiple on-chip computation units, i.e., tiles 110. The control unit 102 is connected to the host (e.g., CPU) through a host interface. The control unit 102 receives requests from the host and stores them in the request dispatcher 104. The design implements instructions necessary for popular inference services (e.g., CNN), including convolution, vector-vector operations, activation, batch normalization, and pooling.

The accelerator 100 also uses instructions to configure the router interconnects so that it can flexibly enable on-chip communication. The interconnect R receives information from the control unit 102, and passes that information to the tile 110 if it is addressed to that particular tile 110, and does not pass the information to the tile 110 to bypass that tile 110 if the information isn't addressed to that tile 110. The instruction dispatcher, shown in FIG. 2, features an instruction dispatcher controller 108 which keeps track of instruction issues and completion, and also manages and distributes instructions to various processing elements. The controller 108 interprets incoming instructions and determines the appropriate processing units to handle them. The controller 108 generates addresses for the instruction buffer, which forwards instructions to the decoder unit. The off-chip DRAM is connected to the accelerator through a DRAM interface. A crossbar is implemented to increase the endpoint bandwidth at the DRAM interface and support all-to-all communication. The accelerator adopts a tiled-based design, and FIG. 2 shows 4×4 tiles 110 are connected through the flexible interconnect as an illustration.

### Tile 110 and PE Architecture

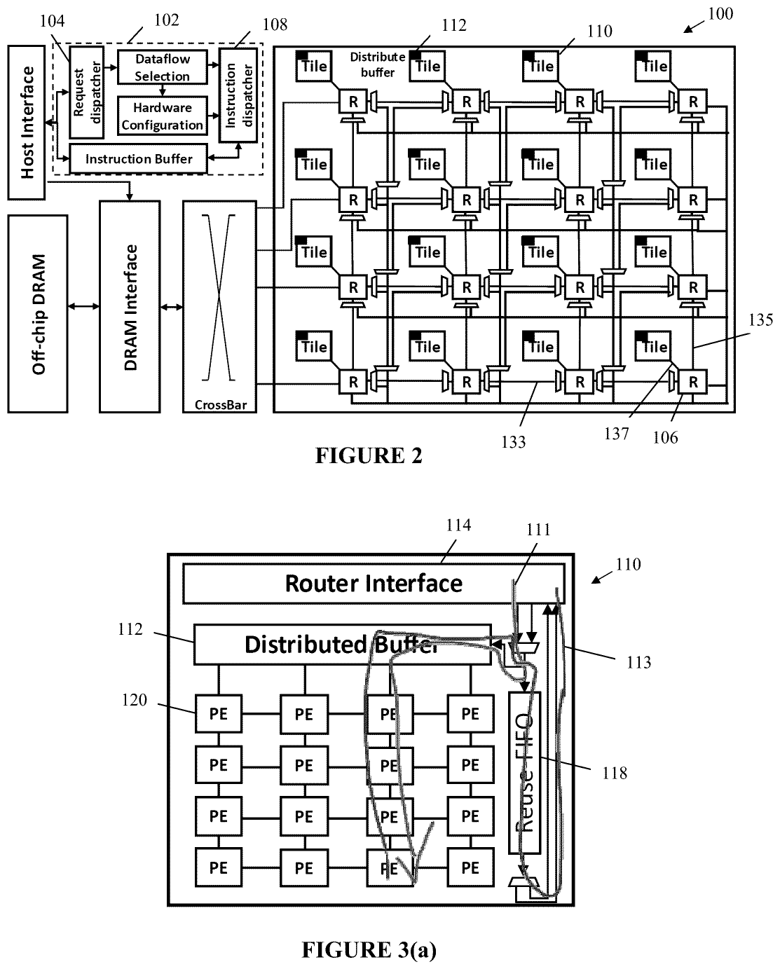

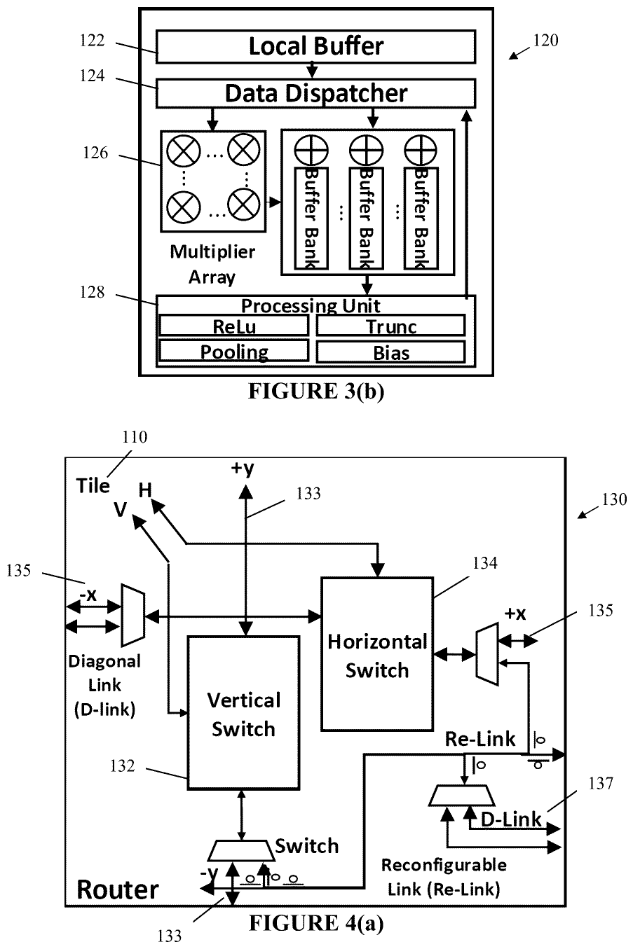

Referring to FIG. 3(a), each tile 110 includes a distributed buffer 112, a router interface 114, a spatial architecture with a 4×4 processing element (PE) 120 array, and a reuse First-in-First-Out (FIFO) buffer 118. The reuse FIFO 118 can temporarily store the data it received from the interconnect R and send locally stored data to its neighbors, acting as a double buffer [11], which can support inter-tile communication. This is designed to enable the data exchange between distributed buffers 112, reducing off-chip memory access. Arrow 111 how the data gets in the tile, and Line 113 shows how the data gets out the tile

The buffers 112 are distributed in that they are spread across multiple locations rather than being centralized in a single memory unit. As shown, the distributed buffers 112 is buffer storage that is spread across multiple tiles 110. The data stored in the distributed buffer 112 can be used only for that specific tile 110, or can be used with neighboring tiles 110. Since the buffers 112 are distributed across the tiles 110, data can be processed in parallel rather than waiting for a centralized buffer. Multiple buffers allow simultaneous access by different parts of the system, avoiding bottlenecks caused by a single shared buffer. Distributed buffers bring data closer to where it is needed, reducing access time. Centralized buffers can become overwhelmed if too many processes access them at once. Distributed buffers spread the load. and it also can improve the memory bandwidth utilization. The PEs 120 receive data from the distributed buffer 112 through the wires between them directed by the control units 102 shown in FIG. 2. The PE 120 receives the data and stores the data in the local buffer 112.

In addition, the reuse FIFO 118 can temporarily store the data it receives and send locally stored data to its neighbor tiles 110, acting as a double buffer [11], which can support inter-tile communication. This is designed to enable the data exchange between distributed buffers, reducing off-chip memory access. Thus, the Reuse FIFO 118 is used for data exchange between tiles 120, whereas the distributed buffer 112 is used within the tile 120. While the distributed buffer 112 is shown as a separate component than the Reuse-FIFO 118, in some implementations those buffers can be combined.

The dataflow selection units generate the optimal dataflow instructions and send them to the instruction dispatcher. And the instruction dispatcher 108 send the instruction signal to control how the data moves from the distributed buffer 112 to the PE 120, for example as based on Algorithm 1.

Turning to FIG. 3(b), each PE 120 includes a local buffer 122, a data dispatcher 124, an MAC array 126, and a processing unit (e.g., ReLu) 128.

### Flexible NoC Design

Each tile in Versa-DNN connects to a dynamically reconfigurable Network-on-Chip (NoC), which includes horizontal, vertical, and diagonal directional links. These links can be activated or deactivated at runtime through control muxes to form optimized communication paths. The interconnect supports localized ring topologies as well as all-to-all or hierarchical configurations depending on workload patterns. The reconfigurable routing enables low-latency, hop-minimized data propagation across tiles, supporting high-throughput multi-model execution.

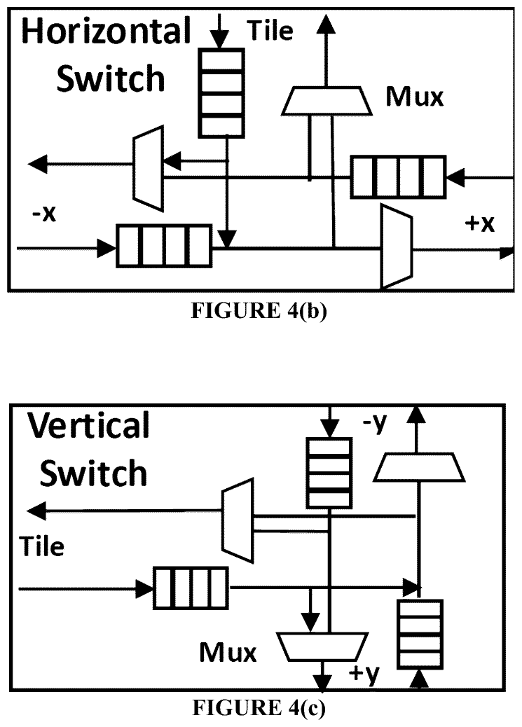

Referring to FIG. 4(a), the flexible NoC (all links except the grid links) includes a flexible router 130 (interfaces with the flexible router through 110), reconfigurable links (Re-Link and De-Lin), and diagonal links. The Re-Link and D-link are part of R.

Even though altering dataflow can optimize the off-chip memory access, the distributions of matrices could also lead to various communication patterns. Previous work has addressed the communication challenges raised by the dynamic dataflows in the unified global buffer, the communication behaviors among distributed buffers remains unexplored.

In general, the flexible NoC design enables data propagation between adjacent tiles 110. This reduces the complexity of data exchange and avoid complicated communication protocols. Specifically, the NoC design can be partitioned into multiple ring topologies with any size and location. The NoC partition, and the mux and demux are used to partition. These rings will be formed to propagate the weights and input activations. One novelty is the configuration of the muxes and demuxes to generate different datapaths.

### Flexible Router 130

The major functionality required for ring topology is to forward and eject/inject in-flight packets. The ring is formed by multiple Tiles connected in a circular sequential configuration, which facilitates routing by having the PE communicate only with its neighbors. The packets are ejected and injected to reuse the data that holds neighbor PE to reduce the expensive off-chip DRAM.

This significantly simplifies the router design with much-reduced radix. Simpler Router Design is achieved by a lower radix, which reduces the complexity of the router, making it easier to design and implement. This can result in reduced area and power consumption for the router. A smaller radix reduces the number of input and output ports, leading to faster traversal through the router due to fewer crossbar connections and simpler arbitration logic, and lower latency. With fewer ports and simplified logic, the router consumes less power, which is beneficial for energy efficiency in high-performance systems.

As shown in FIGS. 4(a)-4(c), the flexible router interfaces with 114 has a vertical switch 132 (FIG. 4(c)) and a horizontal switch 134 (FIG. 4(b)). The vertical switch 132 processes column-wise communication along Vertical Links (V-Link) 133, and the horizontal switch processes row-wise communication along Horizontal Links (H-Link) 135. Vertical switches are connected to a reconfigure device with reconfigurable links (called Re-link in FIG. 4(a)), and the vertical switch is also connected to the D-link; and horizontal switches are connected to Re-link and diagonal links 137 (called D-link in FIG. 4(a)). [In FIG. 4a, the H shows the input/output from the H-Switch, and the V shows the input/output from the V-switch.

The reconfigure or Re-link device has multiple simple transistors to turn on/off the link connection between two adjacent routers 130, avoiding signal interference. The switches in the D-Link and V-Link are configured by the NoC configuration control unit. The Re-link also connects the vertical and horizontal switches in the same router 130 together to fully utilize the radix. D-link is used to connect a pair of routers 130 residing across the diagonal, which can effectively reduce the communication distance and hop count and bridge non-adjacent routers.

The vertical switch processes the column-wise communication, and the horizontal switch processes the row-wise communication. Vertical switches are connected to reconfigurable links (Re-link), and horizontal switches are connected to Re-link and diagonal links (D-link). The Re-link consists of multiple simple transistors to turn on/off the link connection between two adjacent routers, avoiding signal interference. The Re-link also connects the vertical and horizontal switch in the same router together to fully utilize the radix. D-link is used to connect a pair of routers siting across the diagonal, which can effectively reduce the communication distance and hop count and bridge non-adjacent routers.

### Flexible Dataflow

Versa-DNN supports multiple dataflow strategies including weight-stationary (WS), input-stationary (IS), row-stationary (RS), and output-stationary (OS), selected dynamically at runtime. The system employs a nested-loop parallelization engine that analyzes each DNN layer's input shape, filter dimensions, and stride to determine optimal tiling and parallelism factors {Px, Py, Pc, Pn}. These factors are selected to ensure no cross-tile data duplication, balanced computation across tiles, and maximized on-chip data reuse. The dataflow engine partitions weight and input matrices along multiple axes to allow flexible mapping to tile arrays without increasing DRAM traffic.

A variety of dataflows have been explored to reduce the off-chip memory access in current DNN accelerators, but very few of them can be effectively applied to an accelerator design with distributed buffers 112. The major issue with a distributed buffer setup is data duplication or complicated communication patterns. For example, Simba proposed a weight-stationary dataflow in a chiplet-based DNN accelerator, and its dataflow could result in reduced inter-chiplet communications (given the limited inter-chiplet bandwidth) but at a considerable cost of data duplication at each chiplet. To address this limitation, designing a flexible dataflow with simplified communication and eliminating data duplication would require two elements: a thorough study and analysis of parallelism strategies that can minimize data duplication and reduce DRAM access; and a dataflow selection algorithm that can select the optimal dataflow with the least DRAM access and data duplication.

### Parallelism Strategies

To analyze the parallelism strategies or to answer the raised question, we need to examine the root cause of data duplication in existing designs.

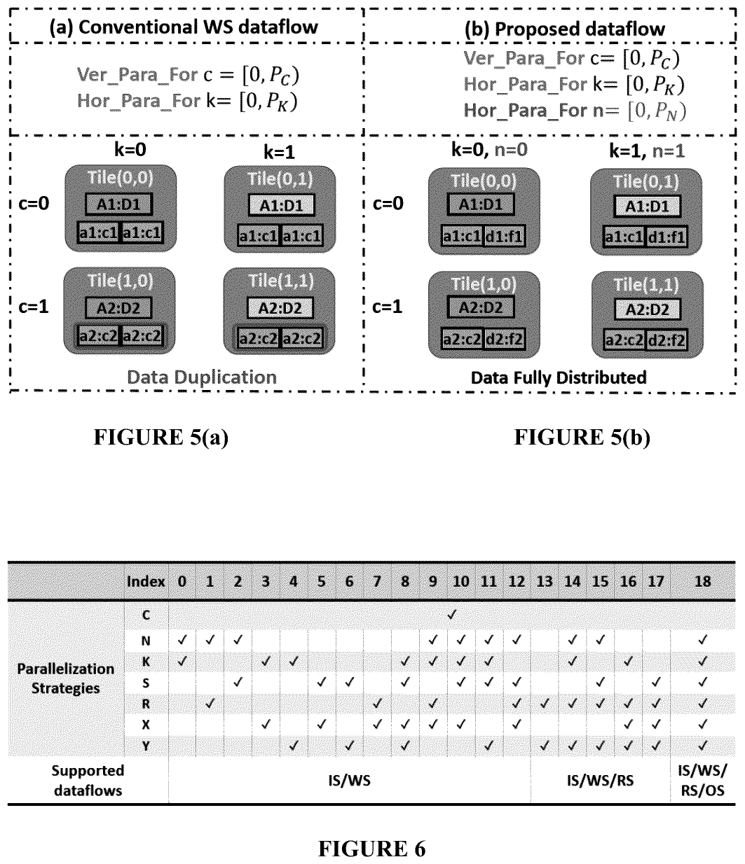

FIG. 5(a) shows the nested loop representation of a parallelism strategy and mapping example of the tiled convolutional layer with weight-stationary (WS) dataflow [13], [14]. The tiled weight and input matrices are distributed into each distributed buffer 112. The number of partitioned matrices is called parallel factors Pᵢ. The attributes c and k are spatially parallelized (denoted as Ver_Paral_For and Hor_Paral_For) on a 2×2 tile-based accelerator in the horizontal and vertical direction. Since attributes k and c are the indexes of the weight matrix (W_{[k][c][r][s]}), the weight matrix is fully distributed across all the tiles. On the other hand, the input matrix (I_{[n][c][x][y]}) is independent of k, and therefore, the input partition remains duplicated at each row. Because of the data duplication, the on-chip buffer 112 cannot be effectively utilized. This further diminishes the on-chip data reuse opportunities, and thus it could affect the DRAM access. The control unit 102 controls the dataflow.

To meet the mentioned dataflow requirements, we need to examine the root cause of data duplication in existing designs. The primary reason is that only one index (c) of the input matrix (I_{[n][c][x][y]}) is parallelized in a two-dimensional accelerator design. As such, to fully distribute a matrix, at least two indexes need to be distributed across each row and column.

We use a parallelism strategy depicted in FIG. 5(b) to illustrate the concept. For a nested loop with multiple attributes, both weight and input matrices can be partitioned and distributed in 2×2 tiles. Each tile 110 has a distributed buffer 112 to store all the input, weight, and output matrices. If attributes c and n are parallelized in different directions (Horizontally and Vertically), the input matrix will be fully distributed across each row and column. Similarly, the weight matrix will be fully distributed, as c and k are the two weight matrix attributes. As a result, onchip buffers 112 can be fully utilized, and the dataflow can effectively reduce off-chip memory access thanks to optimized data reuse. Our current analysis can be extended to any parallelism dimensions.

If attributes C, K, R, and S are parallelized, the weight matrix will be fully distributed across each row and column, as these are four attributes of the weight matrix. Similarly, if attributes C, N, X, and Y are parallelized, the input matrix will be distributed across each row and column.

Several parallelism strategies are viable to mitigate the data duplication issue, but some of them come with complicated communication patterns. To further address the communication complexity problem, we aim to select those dataflows with simple data movement patterns like a ring. This requires that both input and weight matrices be partitioned with an equal number of indexes, and that attribute c be parallelized, as each channel is independent of others and there is no communication between input and weight matrices across different channels.

As a conclusion, the dataflow must meet the following three requirements: (1) at least two indexes of both weight and input matrices must be parallelized across each row and column, (2) both weight and input matrices must be partitioned with an equal number of indexes, and (3) attribute c must be parallelized.

All the supported dataflow candidates are shown in FIG. 6. The dataflows that can efficiently be applied to a design with a distributed buffer have three requirements: (1) at least two indexes of both weight and input matrices have to be parallelized across each row and column, (2) both weight and input matrices have to be partitioned with the equivalent number of indexes, and (3) attribute c must be parallelized.

### Dataflow Selection

The primary goal of dataflow selection is to reduce off-chip memory access. This achieved by Algorithm 1 selecting the optimal parallel strategy. The off-chip memory access is determined by two factors: the data volume of each invocation (e.g., each communication with the off-chip DRAM) and the number of invocations.

To better illustrate the problem, we use an example depicted in FIG. 5. Recall that the DNN layer (l) is represented with multiple attributes (i, i∈{N, K, C, S, R, X, Y, X′, Y′} and X′=X−S+1, Y′=Y−R+1). After the loop tiling, the tiled weight and input matrices have to be distributed into multiple tiles. The number of partitioned matrices is called parallel factors (Pᵢ). And, the data volume of attributes in each partitioned matrix is represented as iₚₐᵣ. For example, input channel C is partitioned into P_{C} parts, and each part has Cₚₐᵣ elements.

Algorithm 1: Dataflow Parallelism Optimization

| Input: Possible fully partitioned and multi-dimension | | | |
|---|---|---|---|
| parallel dataflow candidates DF | | | |
| Input: Dimensions of the DNN layer of each DNN layer | | | |
| i^{l}, i ∈ {K, C, R, S, N, X, Y} , l ∈ [0, L) | | | |
| Input: Dimensions of the a sub-layer in distributed buffer | | | |
| ${i}_{par}^{l} , i ∈ \{ K , C , R , S , N , X , Y \} , l ∈ [ 0 , L )$ | | | |
| Input: Distributed buffer capacity C_{DB} | | | |
| $Output : Parallelfactor : {P}_{i}^{l} , i ∈ \{ K , C , R , S , N , X , Y \} , l ∈$ | | | |
| [0, L) | | | |
| Output: Optimal Dataflow | | | |
| 1 | for l ∈ [0, L) do | | |
| 2 | \| | for Pᵢ^{l} ∈ DF do | |
| 3 | \| | \| | // Data volume involved in cach |
| | \| | \| | invocation |
| 4 | \| | \| | $Calculate {V}_{d}^{l} , d ∈ \{ wt , ifmap , psum \} , l ∈ [ 0 , L ) ;$ |
| 5 | \| | \| | // Number of invocations |
| 6 | \| | | $Calculate {R}_{d}^{l} , d ∈ \{ wt , ifmap , psum \} , m ∈ [ 0 , L ) ;$ |
| 7 | \| | \| | // Number of invocations |
| 8 | \| | \| | DA^{l} = Σ_{d}V_{d} × R_{d}, d ∈ {wt, ifmap, psum}, l ∈ |
| | | | [0, L); |
| 9 | \| | \| | for datavolume^{l} ∈ [0, C_{DB}] do |
| 10 | \| | \| | \| Find the Minimal DA^{l}; |
| 11 | \| | \| | end |
| 12 | \| | \| | return Pᵢ^{l}; |

| | | |
|---|---|---|
| 13 | \| | end |
| 14 | \| | return Optimal Dataflow |

| | |
|---|---|
| 15 | end |

To estimate the DRAM access volume (DA) for the dataflow, we calculate the product of the data volume involved in each invocation (V_{d}) and the total number of invocations (R_{d}) for all data types (i.e., weight(wt), input activation(ifmap), psum(psum)) as shown in Algorithm 1 (Line 7) (i.e., the selection algorithm). The data volume involved in each invocation for different data types can be calculated as V_{wt}, V_{ifmap}, Vₚₛᵤₘ as depicted in Equation 1:

$${V}_{wt} = \prod {i}_{par} \times {P}_{i} , i ∈ \{ K , C , S , R \} \qquad ( 1 )$$

$${V}_{ifmap} = \prod {i}_{par} \times {P}_{i} , i ∈ \{ N , C , X , Y \}$$

$${V}_{psum} = \prod {i}_{par} \times {P}_{i} , i ∈ \{ N , K , {X}^{′} , {Y}^{′} \}$$

The parallel factors determine the accessed array regions of each partitioned matrix, thus different parallel factor configurations imply different dataflows. We observed that different dataflows exhibit large differences in DRAM access volume. The total number of invocations can be calculated as R_{wt}, R_{ifmap}, Rₚₛᵤₘ. We use weight stationary dataflow as an example to explain the equations, but the concept can be generalized to support output/input/row stationary dataflow. The total number of invocations (R_{d}) of weight stationary dataflow can be calculated as depicted in Equation 2:

$${R}_{wt} = \prod \frac{i}{{i}_{par} \times {P}_{i}} , i ∈ \{ K , C , S , R \} \qquad ( 2 )$$

$${R}_{ifmap} = \prod \frac{i}{{i}_{par} \times {P}_{i}} , i ∈ \{ N , K , C , S , R , {X}^{′} , {Y}^{′} \}$$

$${R}_{psum} = \frac{{\prod }^{i ∈ \{ N , K , S , R , {X}^{′} , {Y}^{′} \}} i \times ( \frac{2 C}{{C}_{1} \times {P}_{C}} - 1 )}{{\prod }^{i ∈ \{ N , K , S , R , {X}^{′} , {Y}^{′} \}} {i}_{par} \times {P}_{i}}$$

The data volume of the partitioned matrices (datavolume) can be calculated as Equation 3:

$$datavolume = \prod {i}_{par} , i ∈ \{ K , C , S , R \} + \prod {i}_{par} , i ∈ \{ N , C , X , Y \} + \prod {i}_{par} , i ∈ \{ N , C , {X}^{′} , {Y}^{′} \} \qquad ( 3 )$$

The data volume of the partitioned matrices is the accumulation of data volume for weight matrix, input activation matrix, and output activation matrix. The data volume of weight matrix are the product of data volume for multiple attributes including K, C, S, and R in each partitioned matrix. The data volume of input activation matrix are the product of data volume for multiple attributes including N, C, X, and Y in each partitioned matrix. The data volume of output activation matrix are the product of data volume for multiple attributes including N, C, X′, and Y′ in each partitioned matrix. The data volume of the partitioned matrices is limited by the distributed buffer 112 capacity (C_{DB}) shown in Algorithm 1 (Line 8). Then we can find the parallel factors that can minimize the DRAM access with the distributed buffer capacity (C_{DB}) limitation.

We compare the total DRAM access volume (DA) of all candidate dataflows (DF) and consider the dataflow with the minimal DRAM access volume as the optimal one for each DNN layer. The dataflow selection algorithm is described in detail in Algorithm 1. We note that the algorithm is performed offline, for example at the CPU/GPU in advance or not in real-time by the Algorithm 1.

### Dynamic Accelerator Scheduler

Versa-DNN includes a runtime scheduler that partitions the 2D tile grid into virtual regions, each assigned to a different DNN model. The scheduler evaluates model characteristics such as compute intensity, memory bandwidth demand, and priority to allocate tiles, interconnect bandwidth, and DRAM access fairly across tasks. It supports reconfiguration of the dataflow and interconnect at runtime to avoid performance bottlenecks. The scheduler also supports pipeline execution across layers or models, ensuring that idle compute or memory resources are dynamically reassigned.

Although pipelining DNN layers could reduce data duplication, the inter-layer dependency could still incur resource underutilization. Each DNN layer has to wait until the completion of the prior layer. In light of this, simultaneously running multiple independent DNN applications could provide better parallelism. This opens up the issue of how shared computing units (i.e., PE 120), buffers (i.e., 112, 122, and NoCs should be effectively allocated among multiple DNN applications.

We provide a scheduling policy to allocate computation and communication resources (e.g., the PEs 120) for running DNN tasks (i.e., independent DNN layers). The scheduler will allocate the accelerator resources to running DNN tasks when any task is completely executed or a new task is added. We note that, whenever a new DNN is dispatched from the host to the accelerator, the DNN model is assigned a fixed user defined priority. The priority is statically predetermined as a configuration parameter [16]. The key idea of the partition algorithm is to fully utilize the accelerator's computation resources by (1) creating independent DNN tasks from multiple DNN applications, (2) scheduling the candidate tasks during runtime to leverage the flexibility of interconnects and co-location of multiple DNN models, and (3) executing them in parallel.

The scheduler follows a two-step procedure: (1) the Candidate Task Selection that decides which candidate layers to execute next (Algorithm 2 Line 2-11), and (2) once the candidate tasks are chosen, the scheduler determines the allocation of resource (number of tiles) by Allocation Policy and considers both the task's running time and its priority level to balance latency and throughput satisfaction (Algorithm 2 Line 13-31).

First, among all multiple DNN models (represented by m) that have been dispatched to the scheduler, the scheduler divides each of them into multiple tasks (represented by l) and selects a group of tasks as candidates to execute according to the directed acyclic graph (DAG). A task can be selected as part of the candidate group if it is independent of all other tasks in the candidate group. The candidate group is updated when any task completes its execution or a new task is added.

Second, the scheduler allocates the resource by considering both the task running time and model priority level to balance latency, throughput, and fairness satisfaction. The scheduler grants an initial number of scores per its priority level for each DNN model, which is statically predetermined as a configuration parameter. The scheduler assigns an initial score to tasks based on the priority level of the DNN model they belong to, as indicated in Algorithm 2 (Line 18). Then Algorithm2 adjusts the number of scores to offer scheduling opportunities to the layers with low priority but have short execution time.

The scheduler distributes these spare resources to running tasks by following a score function depicted in Algorithm 2 (Line 27), and it balances the execution time, communication, and priority satisfaction of each candidate layer.

The score function is derived by comparing the initial score (Score[task]) against its isolated execution time (IsolatedTime[task]), and the scheduler grants IsolatedTime[task] per task's execution time (TimePredict[task]) with all valid computation resources and without interruption shown in Algorithm 2. The isolated execution time is predetermined by the compiler, as a roofline model [7] can estimate the TimePredict[task] that can be expressed as a function of on-chip execution time (TimeOn[task]) and Off-chip DRAM access time (Time Off [task]) as follows:

$$TimePredict [ task ] ← max ( TimeOn [ task ] , TimeOff [ task ] ) \qquad ( 4 )$$

The on-chip execution time can be expressed as a function of on-chip computation time (OnComp[task]) and on-chip communication time (OnComm[task])

$$TimeOn [ task ] ← max ( OnComp [ task ] , OnComm [ task ] ) \qquad ( 5 )$$

On-chip computation time: We model OnComp[task] as follows:

$$OnComp [ task ] ← \frac{MACs [ task ]}{U [ task ] \times F \times MUnit \times Totaltiles} \qquad ( 6 )$$

Where U is the tile utilization rate, F is the operating frequency of the accelerator, MUnit is the number of MAC unit in each tile, and Totaltile means the total number of tile.

On-chip communication time: We model OnComm[task] as follows:

$$OnComm [ task ] ← max ( \frac{iS [ task ]}{iB [ task ]} , \frac{wS [ task ]}{wB [ task ]} , \frac{pS [ task ]}{pB [ task ]} ) \qquad ( 7 )$$

Where iS[task], wS[task], pS[task] are the sizes of different reused data, iB[task], wB[task], pB[task] are the available on-chip bandwidths for different data types.

Off-chip DRAM access time: Total time for each layer (TimeOff [task]), includes the time needed to read input data (input feature and filter weights) from DRAM to scratchpad, and the time needed to write the output feature back from the scratchpad to DRAM. We then express the TimeOff [task] as follows:

$$TimeOff [ task ] ← \frac{DRAM [ task ]}{OffBw} \qquad ( 8 )$$

where DRAM [task] is the total DRAM access of each task obtained by Algorithm 1 and OffBw means the total DRAM memory bandwidth.

This allows even low-priority tasks to gradually increase their scores and get a chance to allocate more computation resources. Consequently, this score function not only fosters throughput but also the priority among the candidate tasks. Finally, the scheduler allocates the spare resources (TotalTiles) proportional to the score of each task, where the allocated number of tiles is rounded down (not up) to the closest integer, shown in Algorithm 2.

### Dynamic Sub-Accelerator Partition and Hardware Reconfiguration

We describe the dynamic partitioning and hardware configuration in support of flexible dataflow for multi-DNN execution. As mentioned, the task scheduler and dataflow selection determine the overall resource allocation and parallelism strategies. Upon the decision, Versa-DNN will be dynamically partitioned into several sub-accelerators, each optimized for its optimal dataflow.

Essentially, the sub-accelerator partitioning is to partition the computation, memory, and communication modules. As the computation and memory modules are distributed, the difficulty is to partition the NoC and configure it to support various dataflows. As such, the NoC of the sub-accelerator will be partitioned into multiple disjoint subNoCs. Each NoC will be configured to support the communication patterns of the selected dataflow method.

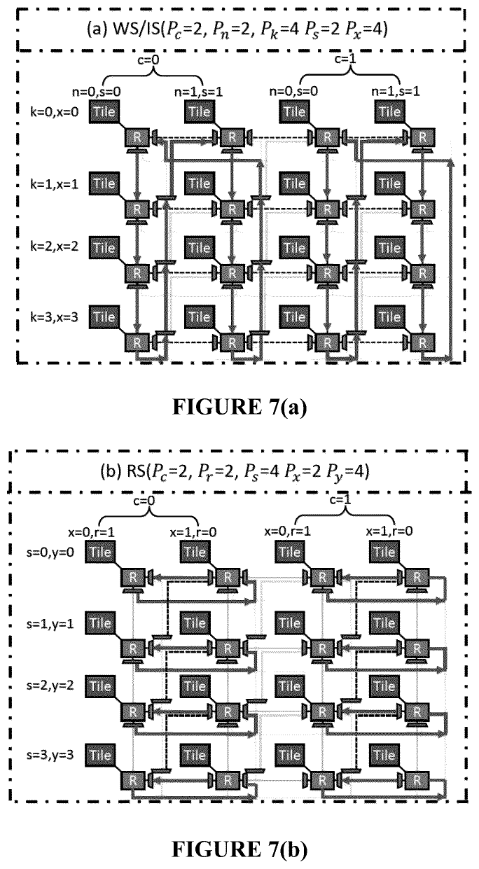

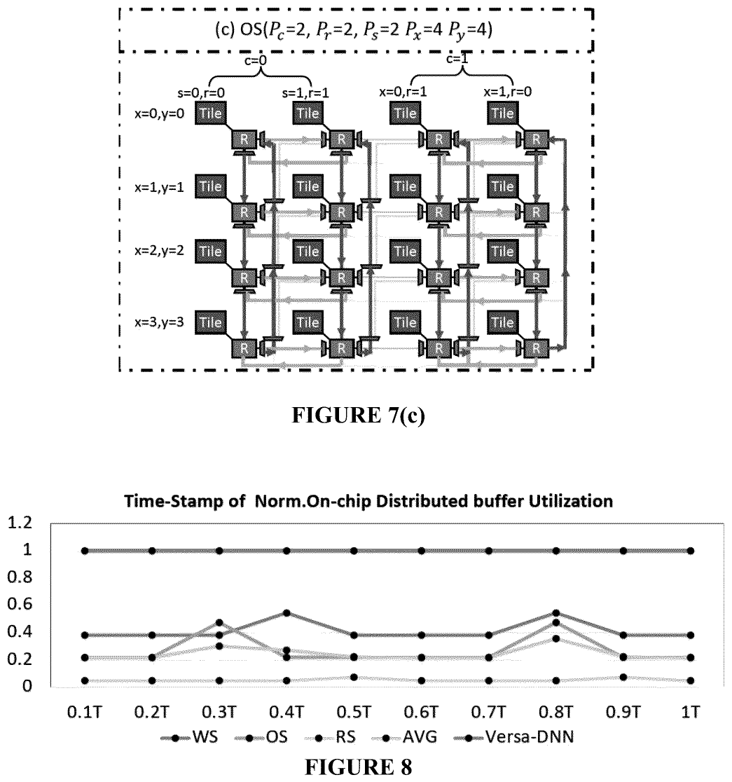

For example, as shown in FIG. 7, multiple rings are configured to support various communication patterns of different dataflows. To better illustrate the design, we provide three examples to represent three different representative dataflows, namely weight-stationary, row-stationary, and output-stationary. The differences among these dataflows include the data movement patterns of input, weight, and partial sums. For example, in FIG. 7(a), a weight stationary dataflow is deployed, where P_{c}=2, Pₙ=2, Pₖ=4, Pₛ=2, and Pₓ=4. As attribute Cis divided into two parts, two rings are generated. In each ring, the input data is forwarded, while partial sums are accumulated horizontally. For RS dataflow shown in FIG. 7(b), inputs are communicated horizontally via those rings, and partial sums are accumulated via diagonal links.

For output-stationary dataflow shown in FIG. 7(b), the weight matrices are propagated horizontally, whereas the input matrices move vertically.

For these examples, we can summarize that each partition with the same attribute C will be clustered into the same ring in weight/input stationary dataflow to transfer input activations or weights. Each partition with same attributes C and Y will be clustered into same ring in row stationary dataflow to forward input activations. In output stationary dataflow, each partition with the same attributes C, X, and Y will be clustered into same ring to transfer input activations and each partition with the same attributes S and R will be clustered into same ring to forward weights. Within each ring, each tile will forward the data to its bottom tile given a simpler routing algorithm. This naturally avoids the deadlock while maintaining the simplicity of the routing.

Network deadlock can occur due to protocol dependency or circular channel dependency. Specifically, the protocol dependency is eliminated by separating the request and reply packets to different virtual networks so that the protocol deadlock is avoided. To prevent circular channel dependency [17], [18], [19], we use the simple yet effective dateline [17].

### Evaluation

### Simulation Setup

We extend Timeloop [20] simulator to support the non-uniform latency and bandwidth between tiles, and the non-uniform latency and bandwidth between PEs. The extended simulation framework is capable of capturing various accelerator activities, such as arithmetic operation, memory access at different levels, and NoC latency and bandwidth. The simulator also considers the consequences of the application of various dataflows and system configurations. The energy consumption of these DRAM read/write operations is modeled by [21].

Multi-DNN workloads: For a fair comparison, we reproduced similar benchmark applications as the ones used in Planaria [6], Herald [1], and AI-MT [5], shown in Table 1.

TABLE 1
Mult-DNN workloads

| Workloads | | DNN Model |
|---|---|---|
| Workload A | Workload A-1 | ResNet-50 [22], GoogLeNet [23], |
| Similar to | | YOLOv3 [24], SSD-R [25], |
| Planaria | | and GNMT [26] |
| | Workload A-2 | EfficientNet-B0 [27], |
| | | MobileNet-v1 [28], SSD-M [25], |
| | | and Tiny YOLO [29] |
| | Workload A-3 | ResNet-50 [22], GoogLeNet [23], |
| | | EfficientNet-B0 [27], MobileNet-v1 [28], |
| | | YOLOv3 [24], SSD-ResNet34 [25], |
| | | SSD-MobileNet [25], Tiny YOLO [29], |
| | | and GNMT [26] |
| Workload B | Workload B-1 | ResNet-50 [22], Unet [30], |
| Similar to | | and MobileNet-v2 [31] |
| Herald | Workload B-2 | ResNet-50 [22], Unet [30], |
| | | MobileNet-v2 [31] |
| | | BR-Q Handpose [32], |
| | | and Focal Length DepthNet [33] |
| | Workload B-3 | ResNet-50 [22], MobileNet-v1 [28], |
| | | SSD-ResNet34 [25], |
| | | SSD-MobileNet-v1 [25], |
| | | and GNMT [26] |
| Workload C | Workload C-1 | VGG-16 [34], ResNet-50 [22], |
| Similar to | | and MobileNet-v1 [28] |
| AI-MT | Workload C-2 | GNMT [26], ResNet-50 [22], |
| | | ResNet-34 [22], and MobileNet-v1 [28] |
| | Workload C-3 | VGG-16 [34], GNMT [26], |
| | | ResNet-50 [22], ResNet-34 [22], |
| | | and MobileNet-v1 [28] |

Accelerator 100 Modeling: We implement the design including 32×32 tiles 110 interconnected by a flexible NoC. Each tile 110 has 4×4 processing elements (PEs) 120, a distributed buffer 112, and a FIFO buffer 118. Each PE has a local buffer 122, data dispatcher 124, MAC array, and processing unit 128 (e.g., ReLu). The on-chip frequency of the accelerator is 700 MHz. The on-chip distributed buffer 112 capacity of each tile 110 is 100 KB. For a fair comparison, we keep the configurations to be consistent for all compared designs (Planaria [6], Herald [1], and AI-MT [5]): All designs use 16384 processing elements 120, and each processing element 120 contains 16 MAC units, the SRAM of each processing element 120 is 5 KB and the total on-chip SRAM capacity is 100 MB.

Dataflow Modeling: For our evaluations, we use our dataflow for the accelerator Versa-DNN. The dataflow is fully distributed and has an optimal parallel policy at the tile level, determined by Algorithm 1 according to different workloads requirements and hardware resource allocation. We use conventional weight stationary dataflow (WS) [14], row stationary dataflow (RS) [4], and output stationary dataflow (OS) [35] for comparison. We implement all compared dataflows on a systolic array-based accelerator platform and our dataflow on the Versa-DNN accelerator to act as a good test for our dataflow to learn and exploit their difference.

Interconnect Configuration: We use the hardware reconfiguration for the configuration of the accelerator. The Interconnection of AI-MT [5] and Herald [1] are fixed. The AI-MT [5] have several systolic arrays of identical and Herald [1] has several heterogeneous sub-accelerators that are optimized for conventional dataflows (WS, OS, and RS). We use the Manual-tuned method for the dynamic architecture fission of Planaria [6].

### On-Chip Distributed Buffer Utilization Analysis

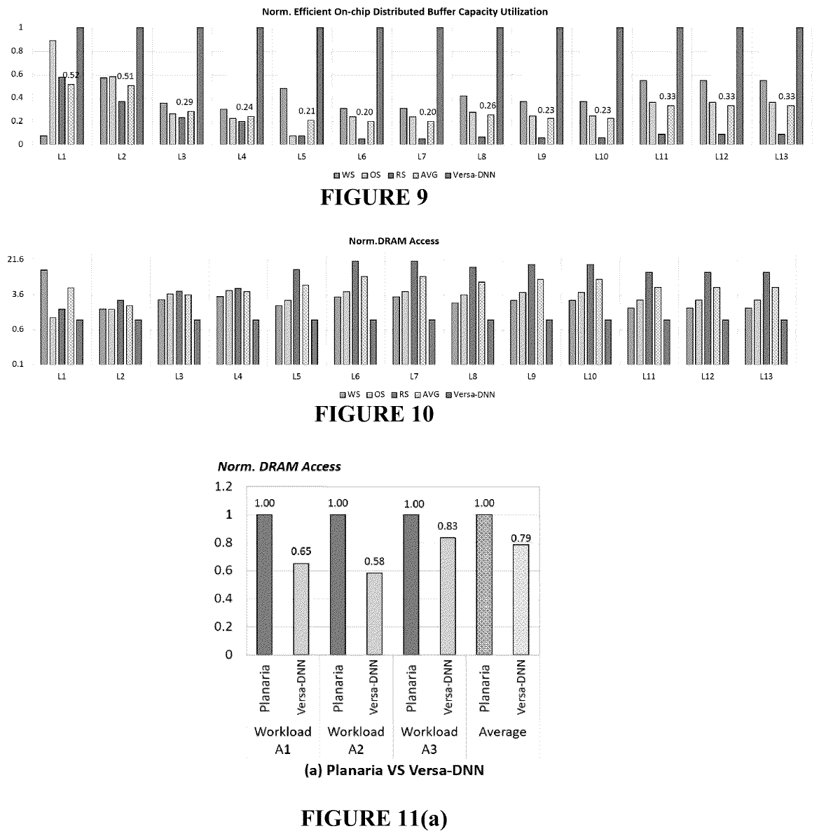

FIG. 8 illustrates the time stamp of normalized efficient on-chip distributed buffer 112 capacity utilization of conventional WS, RS, OS, the average of compared conventional dataflows, and dataflow in a single layer of DNN model VGG-16. The dataflow has higher utilization of on-chip distributed buffers 112 in each time stamp compared to conventional WS, OS, and RS. FIG. 9 illustrates the normalized efficient on-chip distributed buffer capacity utilization for conventional WS [14], RS [4], OS [35], the average of compared conventional dataflows, and the dataflow for each convolutional layer of the DNN model VGG-16 [34]. To improve the efficient utilization of on-chip distributed buffers, the dataflow eliminates the data duplication that exists in conventional dataflows. The dataflow increases the efficient utilization of on-chip distributed buffers 112 for each convolutional layer of the DNN model VGG-16 by an average of 68% compared to WS, RS, and OS. The dataflow can hold more data on-chip, which can help reduce excessive DRAM accesses.

### DRAM Analysis

FIG. 10 illustrates the normalized DRAM Access for conventional WS [14], RS [4], OS [35], the average of compared conventional dataflows, and the dataflow for each convolutional layer of the DNN model VGG-16 [34]. The DRAM accesses include the off-chip DRAM accesses for weights, input activations, and output activations.

The conventional weight stationary dataflow [14] parallelizes over channel and kernel dimensions, and thus it is highly efficient for late layers in CNN-based models. The conventional row stationary dataflow [4] parallelizes across weight and input activation dimensions and excels on the early layers of CNN-based models. The conventional output stationary dataflow parallelizes on output activation dimensions.

The dataflow outperforms the conventional dataflows in a single DNN model because of its higher on-chip distributed buffer utilization (discussed above). Furthermore, conventional dataflows cannot adapt to various parallelism policies and tiling factors. More importantly, they are designed for centralized buffers and have limited applicability to distributed buffer settings. As such, in a single DNN model, the dataflow reduces DRAM Access by an average of 71.9% in each convolutional layer of VGG-16 [34], compared to the average of conventional weight stationary dataflow, row stationary dataflow, and output stationary dataflow.

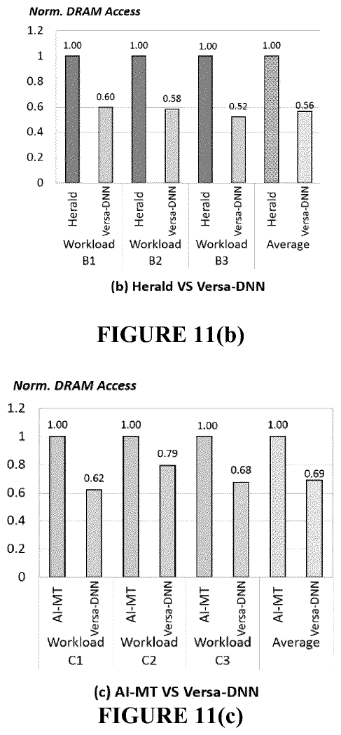

For the same reason, our design reduces DRAM access in multi-DNN workload scenarios. FIG. 11 shows the normalized DRAM access for each workload scenario using our accelerator compared to other accelerators (Planaria [6], Herald [1], and AI-MT [5]). In multi-DNN workload scenarios A1, A2, and A3, our acceleration platform reduces DRAM access by 35%, 42%, and 17%, respectively, compared to the Planaria accelerator [6]. In scenarios B1, B2, and B3, our accelerator, Versa, reduces DRAM access by 40%, 42%, and 48%, respectively, compared to the Herald accelerator [1]. In scenarios C1, C2, and C3, the accelerator reduces DRAM access by 38%, 21%, and 32%, respectively, compared to the AI-MT accelerator [5].

### Throughput Analysis

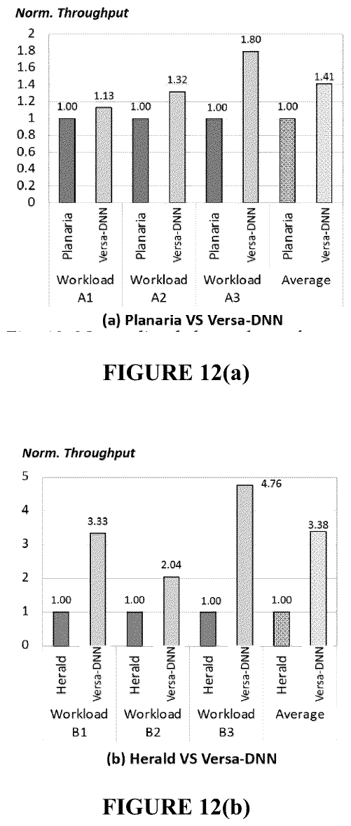

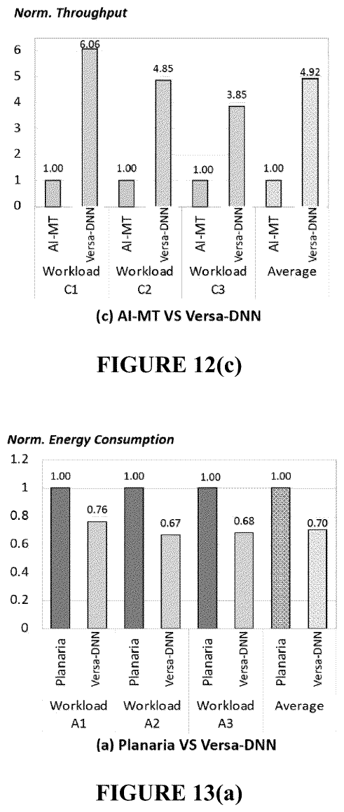

Throughput is the main performance metric for the evaluation of server scenarios for inference tasks in MLPerf [36] and AR/VR [37]. FIG. 12 compares the throughput of the design with Planaria [6], Herald [1], and AI-MT [5] across various workload scenarios while meeting the priority requirements. The design outperforms the compared accelerator platforms in all workload scenarios. Herald [1] executes the DNN layers sequentially, but AI-MT [5], Planaria [6], and the design run multiple independent sublayers or layers in parallel, which can fully utilize the on-chip hardware resource and layer-wise parallelism. All baseline designs utilize fixed parallelism and were originally designed for centralized buffers. As a result, these designs may lead to data duplication when used with distributed buffers.

Our architecture can support multiple fully distributed dataflows with an optimal parallelism strategy that can eliminate data duplication and minimize DRAM access at runtime. The acceleration platform increases throughput by 1.13×, 1.32×, and 1.80× compared to the compared acceleration platform Planaria [6] in multi-DNN workload scenarios A1, A2, and A3, respectively. The performance gains of our design come from better hardware utilization provided by the adaptive dataflow design, as each layer of those DNN models can be optimized individually. In contrast, the hardware resources of prior work are underutilized due to inadequate dataflows in workloads A1, A2, and A3.

The acceleration platform increases throughput by 3.33×, 2.04×, and 4.76× compared to the compared acceleration platform Herald [1] in multi-DNN workload scenarios B1, B2, and B3, respectively. This trend can be traced back to the capabilities of the accelerator compared to Herald [1]. Unlike Herald, the accelerator is capable of executing different layers from different models concurrently through the implementation of a scheduling algorithm 2. The DNN models in workload scenarios B1, B2, and B3 involve significant amounts of depth-wise/point-wise convolutions, where data-level parallelism has very limited performance. The design demonstrates superior performance in resource utilization for these types of convolutions by simultaneously running multiple independent tasks to exploit the task-level parallelism.

The acceleration platform increases throughput by 6.06×, 4.85×, and 3.85× when compared to AI-MT [5], in multi-DNN workload scenarios C1, C2, and C3, respectively. Even though AI-MI can support the simultaneous execution of multiple DNN layers, it still suffers from resource underutilization caused by the rigid PE design and fixed dataflow. This issue is addressed in our design via the architecture and dataflow flexibility.

### Energy Consumption Analysis

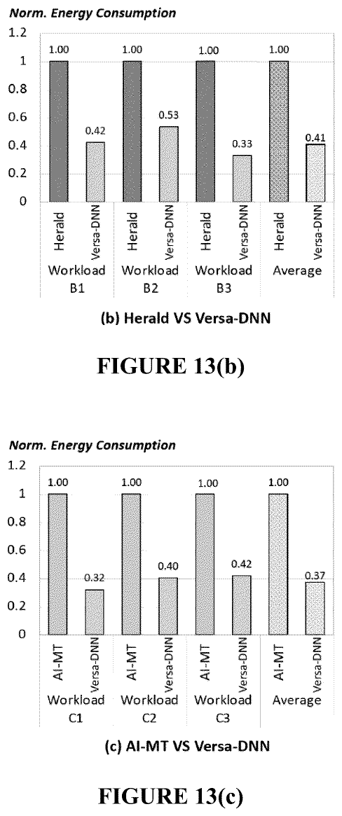

For energy analysis, we utilize a customized version of the open-source Timeloop simulator [20] to obtain power consumption and execution time. It should be noted that the evaluation takes into account the energy consumption of the entire system, including control units 120, computation units, DRAM, distributed buffer 112, local buffer 122, and interconnects R (though in some embodiments not the compute unit or PE). FIG. 13 presents the normalized overall energy consumption analysis of the accelerator. As shown, the acceleration platform increases throughput by 24%, 33%, and 32% compared to the Planaria platform [6] in multi-DNN workload scenarios A1, A2, and A3, respectively. The acceleration platform increases throughput by 58%, 47%, and 67% compared to the Herald platform [1] in multi-DNN workload scenarios B1, B2, and B3, respectively. The acceleration platform increases throughput by 68%, 60%, and 58% compared to the AI-MT platform [5] in multi-DNN workload scenarios C1, C2, and C3, respectively. The main factors contributing to these reductions are the reduction in DRAM access (due to the dataflow) and the dataflow selection algorithm 1, a simple interconnect, reduced long-distance communication (owing to the multiple dimensions parallelism strategy), and low configuration time (attributed to hardware reconfiguration).

### Area Analysis

We evaluate the area consumption of the various architectures under TSMC 40 nm technology, the MAC array consumes only 7.1% of the total PE area, while the memory hierarchy, consumes a majority fraction, 82.9%, of the total area. The PE control unit consumes 3.7% of the total PE area. The total area consumption takes PE, SRAM, flexible interconnect, and control logic into account. For the entire accelerator, the PE array, which has 16384 PEs consumes a major fraction of the overall chip area, which implies 65.23% total chip area. The controller 102 consumes 0.6% total chip area which is negligible. The additional components for the flexible interconnect including flexible routers, reconfigurable links, diagonal links, and muxes consume 3.7% of the total chip area.

### Related Work

### Heterogeneous NoC Designs

In addition to reconfigurable NoC topologies, prior research [38], [39], [40], [41], [42], [43] we can combine the benefits of various topologies in a holistic manner. A hierarchical ring topology, with local and global rings, is designed to take both local and global communication into consideration. Asit et al. [42] designed a heterogeneous NoC consisting of two subnetworks with optimized bandwidth and latency. In addition to these heterogeneous designs, high-radix on-chip networks [39], [40] often deploy both concentration and bypassing techniques to keep the NoC latency scaling to increased NoC size while maintaining the area and wiring costs. However, these designs only provide the flexibility in space but have restricted flexibility in handling diverse communication behaviors at runtime.

### Optimized DNN Dataflow

In the field of hardware acceleration for machine learning, various dataflows have been proposed to optimize data access and communication patterns. Chen et al. performed a classification of neural network accelerators based on their data reuse characteristics, including weight stationary, output-stationary, and row-stationary dataflows. These dataflows determine the mapping of data to Processing Elements (PEs) in different ways, which affects the spatial and temporal utilization of data. Furthermore, Yang et al. [12], [44], [45], [46] broadened the scope of the dataflows utilized in contemporary Neural Network (NN) accelerators by providing a comprehensive taxonomy of these dataflows. This work underscores the importance of understanding the interplay between dataflow design and hardware acceleration for NN computation.

### Multi-DNN Accelerators

Several DNN accelerators with varying dataflows have been proposed in recent years. These accelerators are implemented on a monolithic processing array and focus on improving data reuse, assuming uniform latency and bandwidth across all processing elements (PEs). However, the increasing size of DNN models has led to the development of scale-up systems, such as distributed architectures. Shao et al. implemented a DNN on a distributed architecture using an electrical mesh network for inter-tile communication. Despite using aggressive electrical wire technology, this approach still becomes a performance bottleneck as the system scales, highlighting the scalability limitations of electrical networks at the chiplet scale. Shen et al. investigated the use of multiple FDA sub-accelerators, which they referred to as convolutional layer processors, running the same dataflow in FPGAs [47]. PREMA [7] developed a scheduling algorithm for preemptive execution of DNNs on a monolithic accelerator and utilized time-sharing for multi-DNN. AI-MT [5], on the other hand, developed an architecture that supports multi-DNN by first tiling the layers at compile time and then exploiting hardware-based scheduling to maximize resource utilization. This approach employed multiple systolic arrays within an accelerator chip and parallelized computation tiles of each layer. Planaria [6] explored the design of an architecture for spatial co-location of DNNs for multi-DNN acceleration and addressed its unique scheduling challenges.

### CONCLUSIONS

In this paper, Versa-DNN, a versatile DNN accelerator can provide efficient computation, memory, and communication support for the simultaneous execution of multiple DNNs, which is also suitable for NLP tasks. The Versa-DNN features three unique designs: a flexible off-chip memory access optimization strategy, adaptable communication fabrics and distributed buffers 112, and a communication-aware scheduling algorithm. The off-chip memory access optimization strategy improves the performance and energy efficiency by increasing hardware utilization (e.g., PE, distributed buffer, on-chip bandwidth), eliminating excess data duplication (we never mention this before), and reducing off-chip memory accesses. The adaptable fabrics has distributed buffers 112, processing elements 120, and a flexible Network-on-Chip (NoC), which can dynamically morph and fission to support distinct communication and computation needs for various simultaneously running DNN models. Furthermore, the communication-aware scheduling policy orchestrates the simultaneous execution of multiple DNN models with improved performance and energy efficiency. The Versa-DNN is evaluated using same benchmark DNN models as compared state-of-art accelerators, and the simulation results demonstrate that our Versa-DNN architecture achieves 41%, 238%, 392% throughput speedup and 30%, 59%, 63% energy reduction on average for different workloads when compared to Planaria, Herald, and AI-MT, respectively.

The system provides a versatile DNN accelerator design. It has several potential applications and could lead to the development of various products. Some of the applications and products that may result from this intellectual property include:
1. Processors, domain-specific accelerators: The system can provide a fundamental solution to facilitate existing deep learning applications. The key architecture could be integrated with commercial processors (e.g., RISC-V) to support vector processing, or it can be developed as individual AI/ML chips (e.g., ASIC or FPGA). These products can be widely used in smartphones, IoT devices, edge computing devices, and data center servers to accelerate DNN computations for applications like image recognition, natural language processing, and more. Companies, such as SiFive and tenstorrent, are looking for a similar solution (https://www.sifive.com/about).
2. Multi-Application Support: AI/ML chips are demanding a solution to support multi-model ML applications. Our scheduler is the most effective approach to handle diverse ML models simultaneously from both algorithm and hardware aspects. The key idea could be used in operating systems, ML compilers, chip schedulers, and many computing stages. AMD and Broadcom are looking for solutions to enable multi-tenancy support for AI/ML inference and training. (https://www.broadcom.com/blog/multi-tenancy-for-ai-training-network)
3. Energy-Efficient Computing: Versa's energy-efficient design could lead to the development of products that prioritize energy efficiency in DNN computations. This could be particularly useful in mobile devices and IoT devices where energy consumption is a critical factor.
4. Improved Performance: Versa's architecture could be used to develop products that require high-performance DNN inference, such as real-time video analysis, autonomous vehicles, robotics, and more.
5. Research and Development: The intellectual property could also be valuable for research institutions and companies developing new DNN models, as it provides a flexible and efficient platform for experimentation and testing.

Overall, the Versa-DNN accelerator design has the potential to impact a wide range of applications and products that rely on deep learning inference, offering improved performance, energy efficiency, and versatility.

This disclosure presents a high performance and energy efficient hardware architecture and scheduler that can support diverse deep learning applications. As compared to existing technologies, the solution addresses the limitations of existing accelerators in several ways: (1) Efficient Memory Usage: Versa uses memory more efficiently by reducing data duplication. This means it can store and reuse data more effectively, leading to faster processing and lower energy consumption compared to existing accelerators with centralized memory. (2) Versatile Architecture: Versa is designed to support multiple applications with different dataflows simultaneously. Its flexible architecture can adapt to various traffic patterns and communication needs, making it more versatile than existing accelerators that are limited to specific tasks or dataflows. This versatility improves overall system performance and efficiency. (3) Reduced Expensive Off-Chip Memory Access: By minimizing data duplication and optimizing on-chip data movement, Versa reduces the need for frequent access to off-chip memory. This leads to faster processing and lower power consumption compared to existing accelerators. Simulation results demonstrate that Versa achieves significant improvements in runtime reduction and energy consumption reduction compared to baseline designs (NVDLA, ShiDianNao, Eyeriss, Planaria, Simba). This indicates that Versa can provide superior performance and energy efficiency for deep learning inference tasks.

Overall, the Versa DNN accelerator design offers significant improvements in performance, energy efficiency, and versatility compared to existing technology, making it a valuable advancement in the field of deep learning hardware acceleration.

The following are hereby incorporated by reference in their entireties. [1] H. Kwon, L. Lai, M. Pellauer, T. Krishna, Y.-H. Chen, and V. Chandra, “Heterogeneous dataflow accelerators for multi-dnn workloads,” in Proc. IEEE Int. Symp. High Perform. Comput. Architecture, 2021, pp. 71-83. [2] H. Kwon, P. Chatarasi, M. Pellauer, A. Parashar, V. Sarkar, and T. Krishna, “Understanding reuse, performance, and hardware cost of dnn dataflow: A data-centric approach,” in Proc. IEEE/ACM Int. Symp. Microarchitecture, 2019, pp. 754-768. [3] S. I. Venieris, C.-S. Bouganis, and N. D. Lane, “Multi-dnn accelerators for next-generation ai systems,” ar Xiv preprint arXiv: 2205.09376, 2022. [4] Y.-H. Chen, T. Krishna, J. S. Emer, and V. Sze, “Eyeriss: An energy-efficient reconfigurable accelerator for deep convolutional neural networks,” IEEE J. Solid-State Circuits, vol. 52, no. 1, pp. 127-138, November 2016. [5] E. Baek, D. Kwon, and J. Kim, “A multi-neural network acceleration architecture,” in Proc. ACM/IEEE 47th Int. Symp. Comput. Architecture, 2020, pp. 940-953.
[6] S. Ghodrati, B. H. Ahn, J. K. Kim, S. Kinzer, B. R. Yatham, N. Alla, H. Sharma, M. Alian, E. Ebrahimi, N. S. Kim et al., “Planaria: Dynamic architecture fission for spatial multi-tenant acceleration of deep neural networks,” in Proc. IEEE/ACM 53rd Int. Symp. Microarchitecture, 2020, pp. 681-697. [7] Y. Choi and M. Rhu, “Prema: A predictive multi-task scheduling algorithm for preemptible neural processing units,” in Proc. IEEE Int. Symp. High Perform. Comput. Architecture, 2020, pp. 220-233. [8] S.-C. Kao and T. Krishna, “Magma: An optimization framework for mapping multiple dnns on multiple accelerator cores,” in Proc. IEEE Int. Symp. High Perform. Comput. Architecture, 2022, pp. 814-830. [9] Z. Liu, J. Leng, Z. Zhang, Q. Chen, C. Li, and M. Guo, “Veltair: towards high-performance multi-tenant deep learning services via adaptive compilation and scheduling,” in Proc. ACM 27th Int. Conf. Archit. Support Program. Lang. Operating Syst., 2022, pp. 388-401.
[10] Y. H. Oh, S. Kim, Y. Jin, S. Son, J. Bae, J. Lee, Y. Park, D. U. Kim, T. J. Ham, and J. W. Lee, “Layerweaver: Maximizing resource utilization of neural processing units via layer-wise scheduling,” in Proc. IEEE Int. Symp. High Perform. Comput. Architecture, 2021, pp. 584-597. [11] C. Zhang, P. Li, G. Sun, Y. Guan, B. Xiao, and J. Cong, “Optimizing fpga-based accelerator design for deep convolutional neural networks,” in Proc. ACM/SIGDA Int. Symp. Field-Programmable Gate Arrays, 2015, pp. 161-170. [12] J. Yang, H. Zheng, and A. Louri, “Adapt-flow: A flexible dnn accelerator architecture for heterogeneous dataflow implementation,” in Proc. ACM Great Lakes Symp. on VLSI, 2022, pp. 287-292. [13] Y. S. Shao, J. Clemons, R. Venkatesan, B. Zimmer, M. Fojtik, N. Jiang, B. Keller, A. Klinefelter, N. Pinckney, P. Raina et al., “Simba: Scaling deep-learning inference with multi-chip-module-based architecture,” in Proc. IEEE/ACM 52nd Int. Symp. Microarchitecture, 2019, pp. 14-27. [14] (2017) Nvdla deep learning accelerator. [Online]. Available: http://nvdla.org. [15] M. Gao, X. Yang, J. Pu, M. Horowitz, and C. Kozyrakis, “Tangram: Optimized coarse-grained dataflow for scalable nn accelerators,” in Proc. ACM Int. Conf. Archit. Support Program. Lang. Operating Syst., 2019, pp. 807-820.
[16] P. Minet, E. Renault, I. Khoufi, and S. Boumerdassi, “Analyzing traces from a google data center,” in Proc. IEEE Int. Wireless Commun. Mobile Comput. Conf., 2018, pp. 1167-1172. [17] W. J. Dally and B. P. Towles, Principles and Practices of Interconnection Networks. San Francisco, CA, USA: Morgan Kaufmann Publishers Inc., 2003. [18] C. Carrio'n, R. Beivide, J. Gregorio, and F. Vallejo, “A flow control mechanism to avoid message deadlock in k-ary n-cube networks,” in Proc. 4th Int. Conf. High-Perform. Comput., 1997, pp. 322-329. [19] S. Ma, Z. Wang, Z. Liu, and N. E. Jerger, “Leaving one slot empty: Flit bubble flow control for torus cache-coherent nocs,” IEEE Trans. Comput., vol. 64, no. 3, pp. 763-777, March 2013.
[20] A. Parashar, P. Raina, Y. S. Shao, Y.-H. Chen, V. A. Ying, A. Mukkara, R. Venkatesan, B. Khailany, S. W. Keckler, and J. Emer, “Timeloop: A systematic approach to dnn accelerator evaluation,” in Proc. IEEE Int. Symp. Perform. Anal. Syst. Softw., 2019, pp. 304-315. [21] R. Gonzalez and M. Horowitz, “Energy dissipation in general purpose microprocessors,” IEEE J. Solid-State Circuits, vol. 31, no. 9, pp. 1277-1284 September 1996. [22] K. He, X. Zhang, S. Ren, and J. Sun, “Deep residual learning for image recognition,” in Proc. IEEE Conf. on Comput. Vis. Pattern Recognit., 2016, pp. 770-778. [23] C. Szegedy, W. Liu, Y. Jia, P. Sermanet, S. Reed, D. Anguelov, D. Erhan, V. Vanhoucke, and A. Rabinovich, “Going deeper with convolutions,” in Proc. IEEE Conf. on Comput. Vis. Pattern Recognit., 2015, pp. 1-9. [24] J. Redmon and A. Farhadi, “Yolov3: An incremental improvement,” ar Xiv preprint arXiv: 1804.02767, 2018. [25] W. Liu, D. Anguelov, D. Erhan, C. Szegedy, S. Reed, C.-Y. Fu, and A. C. Berg, “Ssd: Single shot multibox detector,” in Proc. Springer 14th Comput. Vis.-ECCV, Amsterdam, The Netherlands, October 2016, pp. 21-37.
[26] Y. Wu, M. Schuster, Z. Chen, Q. V. Le, M. Norouzi, W. Macherey, M. Krikun, Y. Cao, Q. Gao, K. Macherey et al., “Google's neural machine translation system: Bridging the gap between human and machine translation,” arXiv preprint arXiv: 1609.08144, 2016. [27] M. Tan and Q. Le, “Efficientnet: Rethinking model scaling for convolutional neural networks,” in Proc. PMLR Int. Conf. Machine learning, 2019, pp. 6105-6114. [28] A. G. Howard, M. Zhu, B. Chen, D. Kalenichenko, W. Wang, T. Weyand, M. Andreetto, and H. Adam, “Mobilenets: Efficient convolutional neural networks for mobile vision applications,” arXiv preprint arXiv: 1704.04861, 2017. [29] J. Redmon and A. Farhadi, “Yolo9000: better, faster, stronger,” in Proc. IEEE Conf. on Comput. Vis. Pattern Recognit. IEEE, 2017, pp. 7263-7271. [30] O. Ronneberger, P. Fischer, and T. Brox, “U-net: Convolutional networks for biomedical image segmentation,” in Proc. Int. Conf. Medical Image Comput. Comput.-Assisted Intervention, Munich, Germany, October 2015, pp. 234-241.
[31] M. Sandler, A. Howard, M. Zhu, A. Zhmoginov, and L.-C. Chen, “Mobilenetv2: Inverted residuals and linear bottlenecks,” in Proc. IEEE Conf. on Comput. Vis. Pattern Recognit., 2018, pp. 4510-4520. [32] M. Madadi, S. Escalera, X. Baro', and J. Gonzalez, “End-to-end global to local cnn learning for hand pose recovery in depth data,” arXiv preprint arXiv: 1705.09606, 2017. [33] L. He, G. Wang, and Z. Hu, “Learning depth from single images with deep neural network embedding focal length,” IEEE Trans. on Image Processing, vol. 27, no. 9, pp. 4676-4689, 2018. [34] K. Simonyan and A. Zisserman, “Very deep convolutional networks for large-scale image recognition,” arXiv preprint arXiv: 1409.1556, 2014. [35] Z. Du, R. Fasthuber, T. Chen, P. Ienne, L. Li, T. Luo, X. Feng, Y. Chen, and O. Temam, “Shidiannao: Shifting vision processing closer to the sensor,” in Proc. ACM 42nd Int. Symp. Comput. Architecture, 2015, pp. 92-104. [36] V. Janapa Reddi, C. Cheng, D. Kanter, P. Mattson, G. Schmuelling, C.-J. Wu, B. Anderson, M. Breughe, M. Charlebois, W. Chou et al., “Mlperf inference benchmark,” arXiv e-prints, 2019.
[37] C.-J. Wu, D. Brooks, K. Chen, D. Chen, S. Choudhury, M. Dukhan, K. Hazelwood, E. Isaac, Y. Jia, B. Jia et al., “Machine learning at facebook: Understanding inference at the edge,” in Proc. IEEE Int. Symp. High Perform. Comput. Architecture, 2019, pp. 331-344. [38] R. Das, S. Eachempati, A. K. Mishra, V. Narayanan, and C. R. Das, “Design and evaluation of a hierarchical on-chip interconnect for next-generation cmps,” in Proc. IEEE Int. Symp. High Perform. Comput. Architecture, 2009, pp. 175-186. [39] J. Kim, J. Balfour, and W. Dally, “Flattened butterfly topology for on-chip networks,” in Proc. IEEE Int. Symp. Microarchitecture, 2007, pp. 172-182. [40] H. Zheng, K. Wang, and A. Louri, “A versatile and flexible chiplet-based system design for heterogeneous manycore architectures,” in 2020 57th ACM/IEEE Design Automation Conference (DAC), 2020, pp. 1-6. [41] B. Grot, J. Hestness, S. W. Keckler, and O. Mutlu, “Express cube topologies for on-chip interconnects,” in Proc. IEEE Int. Symp. High Perform. Comput. Architecture, 2009, pp. 163-174. [42] A. K. Mishra, O. Mutlu, and C. R. Das, “A heterogeneous multiple network-on-chip design: an application-aware approach,” in Proc. ACM/EDAC/IEEE Des. Autom. Conf., 2013, pp. 1-10. [43] H. Zheng, K. Wang, and A. Louri, “Adapt-noc: A flexible network-on-chip design for heterogeneous manycore architectures,” in Proceedings of the International Symposium on High-Performance Computer Architecture, 2021. [44] X. Yang, M. Gao, Q. Liu, J. Setter, J. Pu, A. Nayak, S. Bell, K. Cao, H. Ha, P. Raina et al., “Interstellar: Using halide's scheduling language to analyze dnn accelerators,” in Proc. ACM Int. Conf. Archit. Support Program. Lang. Operating Syst., 2020, pp. 369-383. [45] J. Yang, H. Zheng, and A. Louri, “Venus: A versatile deep neural network accelerator architecture design for multiple applications,” in Proceedings of Design Automation Conference (DAC), 2023. [46] L. Yin, J. Wang, and H. Zheng, “Exploring architecture, dataflow, and sparsity for gon accelerators: A holistic framework,” in Proceedings of the Great Lakes Symposium on VLSI 2023, 2023, pp. 489-495. [47] Y. Shen, M. Ferdman, and P. Milder, “Maximizing cnn accelerator efficiency through resource partitioning,” in Proc. IEEE Int. Symp. Comput. Architecture, 2017, pp. 535-547.

In a first embodiment of the disclosure, an accelerator comprises: (a) a reconfigurable on-chip tile array comprising a plurality of adaptable tiles arranged in rows and columns, wherein each of said plurality of tiles includes: (b) a distributed on-chip buffer storing memory data; (c) a configurable array of on-chip processing elements that can be dynamically partitioned into one of several different processing element arrays; (d) a dynamic on-chip router interface that enables adaptable data paths between said array of processing elements to support various different dataflows; (e) a plurality of interconnects, each associated with a respective one of said plurality of tiles, supporting flexible communication patterns between processing elements and off-chip memory; and (f) a control unit configured to control said plurality of tiles and said plurality of interconnects to propagate memory data between said distributed buffers of said plurality of tiles.

In a second embodiment, the accelerator of embodiment 1, wherein said control unit is configured to determine multi-dimensional parallelism optimization for distributed deep neural network (DNN) applications, dynamically selecting the most efficient parallelism strategy based on workload characteristics such as hardware configuration and input data size. In a third embodiment, the accelerator of embodiment 1 or 2, wherein said control unit is configured to provide an adaptive dataflow selection mechanism to avoid data duplication while parallelizing computation. In a fourth embodiment, the accelerator of any one of embodiments 1-3, further comprising: a highly adaptive and scalable flexible router comprising: a horizontal switch configured to efficiently switch horizontal memory data on a dynamically adjustable horizontal link between neighboring tiles in a same row; a vertical switch configured to switch streaming vertical memory data on a reconfigurable vertical link between neighboring tiles in a same column, enabling optimized inter-column communication; and a reconfigure device connected to said horizontal switch to receive the horizontal memory data and said vertical switch to receive the vertical memory data, reconfigure switching on said horizontal switch and said vertical switch, and turn on/off a link connection between adjacent flexible routers.

In a fifth embodiment, the accelerator of any one of embodiments I-4, further comprising a programmable device, coupled to said high-bandwidth horizontal switch and vertical switch, selectively enabling or disabling bypassing link connections between adjacent, routers. In a sixth embodiment, the accelerator of any one of embodiments 1-5, that seamlessly integrates said flexible router and dynamically reconfigurable interconnect links. In a seventh embodiment, the accelerator of embodiments 3, wherein said flexible NoC dynamically configured into multiple ring topologies with same or different size, supporting multiple traffic patterns, and enabling optimia dataflow selection for diverse application workloads. In an eighth embodiment, the accelerator of any one of embodiments 1-7, said control unit operating a scheduling algorithm to allocate computation and communication resources at the processing elements for running DNN tasks. In a ninth embodiment, the accelerator of any one of embodiments 1-8, wherein said control unit comprises a processing device.

In a tenth embodiment, the accelerator of any one of embodiments 1-9, wherein said control unit receives requests from a host computer and configures said plurality of interconnects to flexibly enable on-chip communication. In an eleventh embodiment, the accelerator of any one of embodiments 1-10, wherein said control unit is configured to control said plurality of interconnects to reduce complexity of data exchange and avoid complicated communication protocols. In a twelfth embodiment, the accelerator of any one of embodiments 1-11, wherein said control unit dynamically reconfigures said plurality of tiles into variable-sized subdivisions, adapting to workload-specific parallelism demands. In a thirteenth embodiment, the accelerator of any one of embodiments 1-12, wherein said control unit is configured to control said plurality of interconnects to subdivide said plurality of tiles into multiple subdivisions. In a fourteenth embodiment, the accelerator of any one of embodiments 1-13, wherein said control unit is configured to control said plurality of interconnects to form a ring topology and forward and eject/inject in-flight packets.

In a fifteenth embodiment, the accelerator of any one of embodiments 12 or 14, wherein the ring topologies comprise a flexible router, reconfigurable links and diagonal links. In a sixteenth embodiment, the accelerator of any one of embodiments 1-15, wherein said tile array, said plurality of interconnects and said control unit are on-chip. In a seventeenth embodiment, the accelerator of any one of embodiments 1-13, wherein said distributed buffers of said plurality of tiles trade off expensive off-chip memory accesses, enhancing memory bandwidth utilization and enabling fine-grained parallel data access. In an eighteenth embodiment, the accelerator of any one of embodiments 1-17, wherein said accelerator supports multiple application execution and has a tiled architecture design. In a nineteenth embodiment, the accelerator of any one of embodiments 1-18, wherein said control unit receives requests from a host computer and configures a suitable dataflow from amongst a plurality of dataflows to manage data movement for arbitrary applications.

In a twentieth embodiment, an accelerator comprising: a plurality of tiles arranged in rows and columns to form a tile array, wherein each of said plurality of tiles has a distributed buffer, a router interface, an array of processing elements, and a reuse buffer; a plurality of interconnects, each associated with a respective one of said plurality of tiles; and a control unit configured to control said plurality of tiles and said plurality of interconnects to propagate data between adjacent tiles.

In addition to the embodiments shown and described, the system and method of the disclosure can be implemented by a computer or computing device having a processor, processing device or controller (e.g., controller 108) to perform various functions and operations in accordance with the disclosure. The computer can be, for instance, a personal computer (PC), server or mainframe computer. The processor may also be provided with one or more of a wide variety of components or subsystems including, for example, a co-processor, register, data processing devices and subsystems, wired or wireless communication links, input devices, monitors, memory or storage devices such as a database. All or parts of the system and processes can be stored on or read from computer-readable media. The system can include computer-readable medium, such as a hard disk, having stored thereon machine executable instructions for performing the processes described. All or parts of the system, processes, and/or data utilized in the disclosure can be stored on or read from the storage device(s). The storage device(s) can have stored thereon machine executable instructions for performing the processes of the disclosure. The processing device can execute software that can be stored on the storage device.

As used herein, when an element or feature is described as being “configured,” that element or feature is structurally arranged or formed to accomplish the stated purpose. As used with respect to a processing device (e.g., computer), the term “configured” means that the processing device is structurally arranged or ordered (e.g., by supplying, arranging or connecting a specific set of internal or external components or modules, for example that perform certain operations) to accomplish the stated purpose or task.

The foregoing description and drawings should be considered as illustrative only of the principles of the disclosure, which may be configured in a variety of ways and is not intended to be limited by the embodiment herein described. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. An accelerator system comprising:
a reconfigurable two-dimensional array of tiles, each tile comprising: (i) a distributed on-chip buffer; (ii) a dynamically configurable array of processing elements (PEs); and (iii) a flexible router interface enabling reconfigurable intra- and inter-tile communication;
a plurality of interconnects configured to establish programmable communication paths between said tiles; and
a control unit configured to manage tile behavior, data movement, and scheduling of multiple deep neural network (DNN) models.

2. The accelerator of claim 1, wherein each flexible router interface comprises directionally switchable links including horizontal, vertical, and diagonal connections that are selectively enabled based on communication requirements.

3. The accelerator of claim 1, wherein said control unit is configured to: (i) partition the tile array into virtual execution zones for concurrently running DNN models; (ii) select optimal parallelism and tiling factors for each DNN layer based on workload properties; and (iii) dynamically configure interconnect topologies to reduce communication latency and memory contention.

4. The accelerator of claim 1, wherein the control unit comprises hardware logic configured to determine a dataflow mode selected from weight-stationary (WS), input-stationary (IS), output-stationary (OS), or row-stationary (RS), based on the dimensions of the input, weight, and output tensors.

5. The accelerator of claim 1, wherein said interconnects support ring-based, mesh-based, or hybrid topologies by enabling or disabling individual directional links between tiles, thereby optimizing the communication pattern for varying DNN workloads.

6. The accelerator of claim 1, wherein said control unit comprises a host interface configured to receive requests from an external processor and initiate tile reconfiguration and workload distribution.

7. The accelerator of claim 1, wherein the control unit further comprises a runtime scheduling engine configured to allocate compute and communication resources among multiple DNN tasks based on model priority, latency constraints, and data dependencies.

8. The accelerator of claim 1, further comprising a DRAM interface and a crossbar switch, wherein the crossbar is configured to support all-to-all data communication between the external memory and said tile array.

9. The accelerator of claim 1, wherein each tile includes a reuse buffer configured to temporarily store intermediate results and forward data to adjacent tiles, enabling fine-grained inter-tile reuse and reducing off-chip memory access.

10. The accelerator of claim 1, wherein said system is configured to concurrently execute at least two DNN models, each assigned to a subset of the tile array with independently configured dataflow and routing policies.

11. The accelerator of claim 1, wherein the control unit further comprises logic to monitor real-time tile utilization and dynamically migrate workload partitions to balance compute density across the tile array.

12. The accelerator of claim 1, wherein said interconnects comprise bandwidth-aware switches configured to prioritize communication traffic based on data criticality and congestion status.

13. The accelerator of claim 1, wherein the router interface in each tile is configured to perform local path arbitration based on hop count minimization and link availability.

14. The accelerator of claim 1, wherein the control unit is further configured to select interconnect configurations that minimize energy consumption while maintaining target throughput.

15. The accelerator of claim 1, wherein the control unit supports temporal multiplexing of instructions to enable tile sharing between latency-critical and throughput-oriented DNN models.

16. The accelerator of claim 1, wherein each tile comprises fault-tolerant logic configured to detect and isolate malfunctioning processing elements, enabling graceful degradation and continued system operation.

17. The accelerator of claim 1, wherein the tile array is hierarchically partitioned into clusters, and each cluster is locally managed by a cluster controller configured to reduce global control overhead and enable scalable parallel execution.

18. The accelerator of claim 1, wherein said system supports memory compression logic within each tile to reduce data bandwidth and improve storage efficiency of activation maps and weights.

19. The accelerator of claim 1, wherein the interconnects and tile array are configured to be compatible with multi-chiplet architectures, enabling distribution of tile subarrays across separate physical dies interconnected via high-bandwidth links.

20. The accelerator of claim 1, wherein the control unit is further configured to monitor thermal or power conditions across the tile array and selectively throttle or reassign workloads to maintain thermal safety margins.
